(19) United States
(12) Patent Application Publication
(10) Pub. No.: US 2011/0310794 A1
(43) Pub. Date: Dec. 22, 2011

(54) METHODS OF PROVIDING PAGES INCLUDING CALLING PARTY NUMBER USING A TUNNELING PROTOCOL

(76) Inventors: Ke-Chi Jang, Plano, TX (US); Marvin Bienn, Dallas, TX (US)

(21) Appl. No.: 12/980,509

(22) Filed: Dec. 29, 2010

Related U.S. Application Data
(60) Provisional application No. 61/355,605, filed on Jun. 17, 2010.

(51) Int. Cl. H04W 40/00

(52) U.S. Cl. 370/328

(57) ABSTRACT

A page including a calling party number from a circuit-switched network may be provided to a wireless terminal in wireless communication with a packet-data network. More particularly, a call origination message may be received at the circuit-switched network for the wireless terminal with the call origination message including a calling party number. Responsive to receiving the call origination message at the circuit-switched network, a Generic Circuit Services Notification Application (GCSNA) message may be generated at the circuit-switched network, and the GCSNA message may include a page message and the calling party number. The GCSNA message including the page message and the calling party number may then be transmitted to the wireless terminal through the packet-data network using a GCSNA tunneling protocol. Related methods, terminals and networks are also discussed.

### RELATED APPLICATION

The present application claims the benefit of priority of U.S. Provisional Application No. 61/355,605 entitled “Method far Transmission Of Calling Party Number For A Tunneled CDMA Voice Cull Page Utilizing GCSNA Protocol” and filed Jun. 17, 2010, the disclosure of which is hereby incorporated herein in its entirety by reference.

### TECHNICAL FIELD

The present disclosure is directed to wireless communications and, more particularly, to paging methods and related networks and terminals.

### BACKGROUND

In a typical cellular radio system, wireless terminals (also referred to as wireless mobile terminals, user terminals and/or user equipment nodes or UEs, mobile stations, etc.) communicate via a radio access network (RAN) with one or more core networks. The RAN covers a geographical area which is divided into cell areas, with each cell area being served by a RAN node, e.g., a radio base station (BS), which in some networks is also called a “NodeB” or enhanced NodeB “eNodeB.” A cell area is a geographical area where radio coverage is provided by the base station equipment at a base station site. The base stations communicate through radio communication channels with UEs within the coverage area of the base stations. The type of radio communication channels utilized between the base station and the UE define the radio access technology (RAT). There are circuit-switched radio access technologies that support circuit-switched operations, for example CDMA (code division multiple access) or GSM (Global System far Mobile Communications), and there are packet-data radio access technologies that support packet-data operations, for example High Rate Packet Data (HRPD) or Long Term Evolution (LTE)

A single radio multi-mode mobile (SRMMM) wireless terminal is a wireless terminal configured to use more than one radio access technology to communicate with base stations but can communicate with base stations using only one of these radio access technologies at a time. Stated in other words, an SRMMM wireless terminal may be unable to communicate to base stations using a packet-data RAT when communicating with base stations using a circuit-switched RAT, and an SRMMM wireless terminal may be unable to communicate to base stations using a circuit-switched RAT when communicating with base stations using a packet-data RAT. Examples of a SRMMM include a SRMMM that supports CDMA and LTE, or a SRMMM that supports CDMA, HRPD, and LTE.

A network operator, for example, may provide a basic set of services (e.g., voice call services, short message services) throughout a service area using a circuit-switched radio access technology (e.g., GSM), while using a newer packet-data radio access technology (e.g., LTE) to provide an enhanced set of services (e.g., video teleconferencing, instant messaging) for portions of the service area. Base stations supporting the newer packet-data radio access technology and the enhanced set of services, for example, may initially be deployed in higher more dense traffic regions of the network operator's service area. Backwards compatibility and a basic set of services over the entire service area is provided using the circuit-switched radio access technology. Accordingly, SRMMM wireless terminals may use the newer packet-data radio access technology when available to access the enhanced set of services, and an SRMMM wireless terminal may continue to use the circuit-switched radio access technology and basic set of services where the packet-data network is not available.

Because the enhanced set of services provided by the packet-data radio access technology may not contain some of the services in the basic set of services (e.g., voice call services) provided by the circuit-switched radio access technology, a SRMMM wireless terminal communicating with base stations using a packet-data radio access technology may need to be redirected or handed off to base stations using the circuit-switched radio access technology

### SUMMARY

According to some embodiments, a method of providing a page from a circuit-switched network to a wireless terminal in communication with base stations using a packet-data radio access technology may include receiving a paging request message at the circuit-switched network for the wireless terminal with the paging request message including a calling party number. Responsive to receiving the paging request message at the circuit-switched network, a Generic Circuit Services Notification Application (GCSNA) message may be generated at the circuit-switched network including a page message and the calling party number. The GCSNA message including the page message and the calling party number may be transmitted to the wireless terminal through the packet-data network and the base stations using a packet-data radio access technology using a GCSNA tunneling protocol. By providing the calling party number in the GCSNA message with the page message, a user of the wireless terminal may choose whether to accept or reject the call based on an identification of the calling party (using the calling party number) before interrupting communication with the packet-data network. Accordingly, communications with the packet-data network may continue uninterrupted if the user does not wish to accept the call.

The page message may be included in a first 1x Layer 3 Protocol Data Unit (1xL3 PDU) of the GCSNA message, and the calling party number may be included in a second 1xL3 PDU of the GCSNA message. The Generic Circuit Services Notification Application (GCSNA) message may include a GCSNA header, and the calling party number may be included in a field of the GCSNA header. The Generic Circuit Services Notification Application (GCSNA) message may include a Tunneled Link Access Control (TLAC) header, and the calling party number may be included in a field of the TLAC header. The Generic Circuit Services Notification Application (GCSNA) message may include a Tunneled Link Access Control (TLAC) payload, and the calling party number may be included in a field of the TLAC payload.

The circuit-switched network may include a code division multiple access (CDMA) circuit-switched network, and the packet-data network may include a Long Term Evolution (LTE) packet-data network.

After transmitting the GCSNA message to the wireless terminal, a page response message or a page reject message may be received from the wireless terminal at the circuit-switched network. The page response message or the page reject message may be received through the base stations using a packet-data radio access technology and through the packet-data network using the GCSNA tunneling protocol. Responsive to receiving the page response message, hand-off of the wireless terminal from the packet-data network to the circuit-switched network may be provided. After providing hand-off, a voice call for the wireless terminal may be provided through the circuit-switched network. Responsive to receiving the page reject message, the circuit-switched network may apply supplementary service to the voice call (e.g., forward the voice call to the subscriber's voicemail server).

According to some other embodiments, a method of operating a wireless terminal may include providing communications for the wireless terminal through a packet-data network. A Generic Circuit Services Notification Application (GCSNA) message including a calling party number and a page message may be received from a circuit-switched network. More particularly, the GCSNA message may be received from the circuit-switched network through the packet-data network and through the base stations using a packet-data radio access technology using a GCSNA tunneling protocol.

The page message may be included in a first 1x Layer 3 Protocol Data Unit (1xL3 PDU) of the GCSNA message, and the calling party number may be included in a second 1xL3 PDU of the GCSNA message. The Generic Circuit Services Notification Application (GCSNA) message may include a GCSNA header, and the calling party number may be included in a field of the GCSNA header. The Generic Circuit Services Notification Application (GCSNA) message may include a Tunneled Link Access Control (TLAC) header, and the calling party number may be included in a field of the TLAC header. The Generic Circuit Services Notification Application (GCSNA) message may include a Tunneled Link Access Control (TLAC) payload, and the calling party number may be included in a field of the TLAC payload.

The circuit-switched network may include a code division multiple access (CDMA) circuit-switched network, and the packet-data network may include a Long Term Evolution (LTE) packet-data network.

Responsive to receiving the GCSNA message including the calling party number, an alert to the wireless terminal user may be provided. Responsive to call acceptance alter providing the alert, a page response message may be transmitted through the base stations using a packet-data radio access technology and through the packet-data network to the circuit-switched network using the GCSNA tunneling protocol. Responsive to call acceptance and after transmitting the page response message, hand-off from the packet-data network to the circuit-switched network may be provided. Responsive to call acceptance and after accepting hand-off to the circuit-switched network, a voice call through the circuit-switched network may be provided. Responsive to call rejection after providing the alert, communications for the wireless terminal may continue to be provided through the packet-data network without interruption.

According to still other embodiments, a circuit-switched network may include an InterWorking Solution (IWS) controller. The IWS controller may be configured to receive a paging request message containing a calling party number, to generate a Generic Circuit Services Notification Application (GCSNA) message including a page message and the calling party number contained in the paging request message. The IWS controller may be further configured to transmit the GCSNA message including the calling party number and the page message to a wireless terminal through a packet-data network and through base stations using a packet-data radio access technology using a GCSNA tunneling protocol.

The page message may be included in a first 1x Layer 3 Protocol Data Unit (1xL3 PDU) of the GCSNA message, and the calling party number may be included in a second 1xL3 PDU of the GCSNA message. The Generic Circuit Services Notification Application (GCSNA) message may include a Tunneled Link Access Control (TLAC) header, and the calling party number may be included in a field of the MAC header. The Generic Circuit Services Notification Application (GCSNA) message may include a Tunneled Link Access Control (TLAC) payload, and the calling party number may be included in a field of the MAC payload. The Generic Circuit Services Notification Application (GCSNA) message may include a GCSNA header, and the calling party number may be included in a field of the GCSNA header.

The circuit-switched network may include a code division multiple access (CDMA) circuit-switched network, and the packet-data network may include a Long Term Evolution (LTE) packet-data network.

After transmitting the GCSNA message to the wireless terminal, the InterWorking Solution (IWS) controller may be configured to receive a page response message, signifying call acceptance, or to receive a page reject message, signifying call rejection from the wireless terminal through the base stations using a packet-data radio access technology and through the packet-data network using the GCSNA tunneling protocol. In addition, a mobility controller may be configured to provide hand-off of the wireless terminal from the packet-data network to a selected one of a plurality of base stations responsive to the IWS controller receiving the page response message. The mobility controller may be further configured to provide a voice call for the wireless terminal through the selected base station after hand-off.

According to yet other embodiments, a wireless terminal may include a transceiver and a processor coupled to the transceiver. The transceiver may be configured to provide radio communications with a packet-data network and with a circuit-switched network. The processor may be configured to provide communications through the transceiver with the packet-data network, and to receive a Generic Circuit Services Notification Application (GCSNA) message including a calling party number and a page message from the circuit-switched network while providing communications with the packet-data network. Moreover, the GCSNA message may be received from the circuit-switched network through the packet-data network and the transceiver using a GCSNA tunneling protocol.

The page message may be included in a first 1x Layer 3 Protocol Data Unit (1xL3 PDU) of the GCSNA message, and the calling party number may be included in a second 1xL3 PDU of the GCSNA message. The Generic Circuit Services Notification Application (GCSNA) message may include a Tunneled Link Access Control (TLAC) header, and the calling party number may be included in a field of the TLAC header. The Generic Circuit Services Notification Application (GCSNA) message may include a Tunneled Link Access Control (TLAC) payload, and the calling party number may be included in a field of the TLAC payload. The Generic Circuit Services Notification Application (GCSNA) message may include a GCSNA header, and the calling party number may be included in a field of the GCSNA header.

The circuit-switched network may include a code division multiple access (CDMA) circuit-switched network, and the packet-data network may include a Long Term Evolution (LTE) packet-data network.

A user interface may be coupled to the processor. The processor may be configured to provide an alert through the user interface responsive to receiving the GCSNA message including the calling party number. The processor may be configured to transmit a page response message or a page reject message through the transceiver and the packet-data network to the circuit-switched network using the tunneling protocol responsive to call acceptance or call rejection after providing the alert. The processor may be configured to accept hand-off from the packet-data network to the circuit-switched network responsive to the call acceptance and after transmitting the page response message. The processor may be configured to provide a voice call through the transceiver and the circuit-switched network after accepting hand-off to the circuit-switched network. The processor may be configured to continue providing communications for the wireless terminal through the packet-data network without interruption responsive to call rejection after providing the alert.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram of a communication system that is configured according to some embodiments;

FIG. 2 is a flow chart illustrating operations of network elements according to some embodiments;

FIG. 3 is a flow chart illustrating operations of mobile terminal elements according to some embodiments;

FIGS. 4A to 4F illustrate elements of Global Circuit Services Notification Application (GCSNA) messages according to some embodiments.

### DETAILED DESCRIPTION

The invention will now be described more fully hereinafter with reference to the accompanying drawings, in which examples of embodiments of the invention are shown. This invention may, however, be embodied in many different forms and should not be construed as limited to the embodiments set forth herein. It should also be noted that these embodiments are not mutually exclusive. Components from one embodiment may be tacitly assumed to be present/used in another embodiment.

For purposes of illustration and explanation only, these and other embodiments of the present invention are described herein in the context of operating in a RAN that communicates over radio communication channels with wireless terminals (also referred to as wireless mobile terminals, user terminals, user equipment nodes or UEs, mobile stations, etc.). It will be understood, however, that the present invention is not limited to such embodiments and may be embodied generally in any type of communication network. As used herein, a wireless terminal can include any device that receives data from a communication network, and may include, but is not limited to, a mobile radiotelephone (“cellular” telephone), laptop/portable computer, pocket computer, hand-held computer, and/or desktop computer.

In some embodiments of a RAN, several base stations can be connected (e.g., by landlines or radio channels) to a radio network controller (RNC). The radio network controller, also sometimes termed a base station controller (BSC), supervises and coordinates various activities of the plural base stations connected thereto. A radio network controller may be connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UTRAN, short for UMTS Terrestrial Radio Access Network, is a collective term for the Node B's and Radio Network Controllers which make up the UMTS radio access network. Thus, UTRAN is essentially a radio access network using wideband code division multiple access for wireless terminals.

The Third Generation Partnership Project (3GPP) has undertaken to further evolve the UTRAN and GSM based radio access network technologies. In this regard, specifications for the Evolved Universal Terrestrial Radio Access Network (E-UTRAN) are ongoing within 3GPP. The Evolved Universal Terrestrial Radio Access Network (E-MILAN) comprises the Long Term Evolution (LIE) and System Architecture Evolution (SAE).

Note that although terminology from 3GPP (3^{rd} Generation Partnership Project) LIE (Long Term Evolution) is used in this disclosure to exemplify embodiments of the invention, this should not be seen as limiting the scope of the invention to only these systems. Other wireless systems, including WCDMA (Wideband Code Division Multiple Access), WiMax (Worldwide interoperability for Microwave Access), UMB (Ultra Mobile Broadband) and GSM (Global System for Mobile Communications), may also benefit from exploiting embodiments of the present invention disclosed herein.

Also note that terminology such as eNodeB (Evolved Node B) and UB (User Equipment) should be considering non-limiting and does not imply a certain hierarchical relation between the two. In general an “eNodeB” and a “UE” may be considered as examples of respective different communications devices that communicate with each other over radio communication channels. While embodiments discussed herein may focus on wireless transmissions in a downlink from an eNodeB to a UE, embodiments of the invention may also be applied, for example, in the uplink.

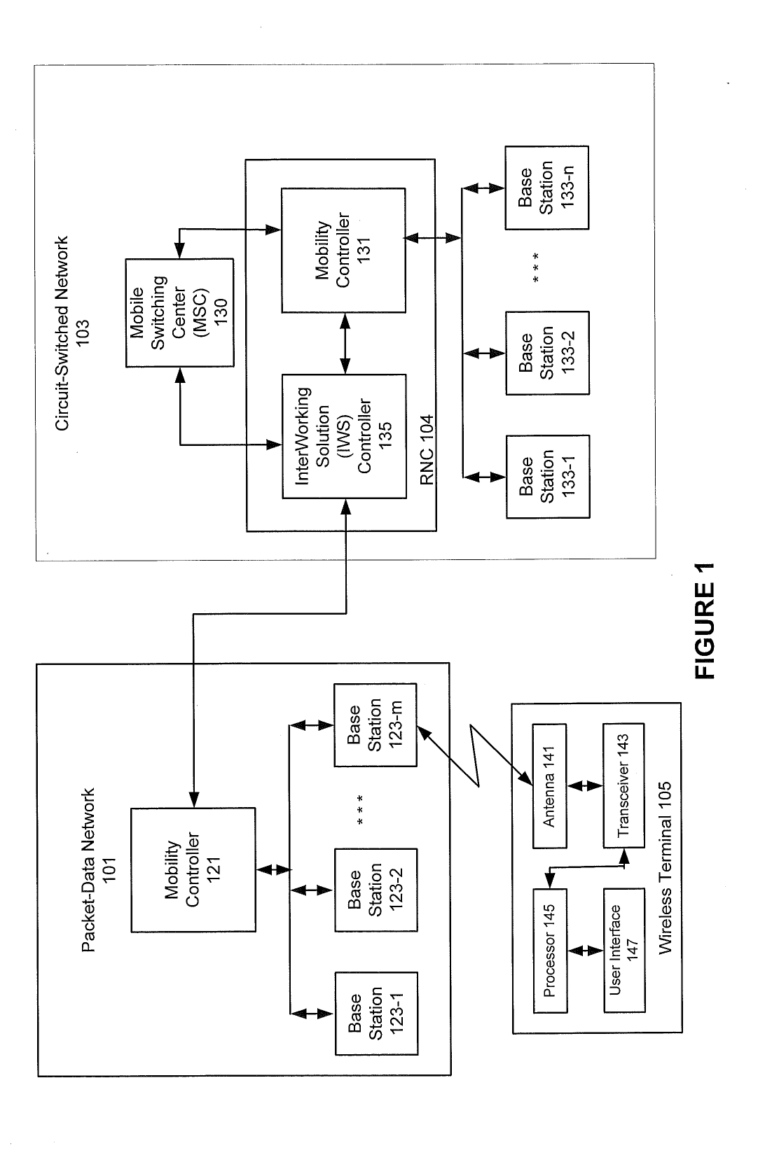

FIG. 1 is a block diagram of communication networks that are configured to operate according to some embodiments. A network operator, for example, may provide a basic set of services throughout a service area using a circuit-switched network 103 (e.g., a code division multiple access CDMA circuit-switched network) while providing an enhanced set of services for portions of the service area using packet-data network 101 (e.g., a Long Term Evolution LTE network).

Circuit-switched network 103 may include a plurality of base stations 133-1 to 133-n configured to provide transmission and reception of radio communications over respective coverage areas. Circuit-switched network 103, for example, may be a CDMA network with base stations 133-1 to 133-n providing a basic set of services, throughout a service area. Base stations 133-1 to 133-n of circuit-switched network 103, for example, may be coupled to a radio network controller (RNC) 104 including mobility controller 131, and interworking solution (IWS) controller 135. The Mobile Switching Center (MSC) 130 is a controller in the circuit-switched network 103 that sets up and releases an end-to-end call session, controls mobility and handover events during the call session, manages billing, and performs other tasks. Packet-data network 101 may include a plurality of base stations 123-1 to 123-m coupled to mobility controller 121. Base stations 121-1 to 121-m may be configured to provide transmission and reception of radio communications in portions of the service area. Base stations 133-1 to 133-n of circuit-switched network 103 may thus provide a basic set of services over all portions of the service area, while base stations 121-1 to 121-m of packet-data network 101 may provide an enhanced set of services over only portions of the service area. The enhanced set of services may not contain some of the services in the basic set of services (e.g., voice call delivery and voice call origination).

Wireless terminal 105 may be an SRMMM wireless terminal configured to communicate with both packet-data network 101 and circuit-switched network 103, but can only communicate with one network at a time. More particularly, wireless terminal 105 may include antenna 141, transceiver 143, processor 145, and user interface 147, and wireless terminal 105 may be able to provide communications with only one of packet-data network 101 or circuit-switched network 103 at a time. When wireless terminal 105 is communicating with packet-data network 101, service through circuit-switched network 103 may be available, but wireless terminal 105 may be unable to receive communications directly from circuit-switched network 105 without interrupting communications with packet-data network 101. When receiving a service (e.g., video downloading, or email) using packet-data network 101, for example, wireless terminal 105 may be unable to receive a page message for an incoming voice call directly from circuit-switched network 103.

As shown in FIG. 1, wireless terminal 105 may communicate with base station 123-m of packet-data network 101 to provide an enhanced set of services. If a remote communications device (e.g., another wireless terminal, a conventional land-line telephone, etc.) places a voice call to wireless mobile terminal 105, however, circuit-switched network 103 may be required to handle the call routing and/or the call. Accordingly, mobile switching center 130 of circuit-switched network 103 may receive a call origination message (e.g., an ISDN User Part (ISUP) initial answer message) including a calling party number identifying the remote communications device (e.g., a telephone number of the remote communications device) making the call request. Because wireless terminal 105 is communicating with packet-data network 101, however, circuit-switched network 103 may be unable to forward a page message directly to wireless mobile terminal 105. Instead, mobile switching center 130 may determine that wireless terminal 105 is in communication with base station 123-m of packet-data network 101. Accordingly, mobile switching center 130 may send a paging request message containing the calling party number to InterWorking Solution (IWS) controller 135. Using a priori information (e.g., a Registration message was previously sent by wireless terminal 105 from packet-data network 101 through IWS controller 135 to MSC 130) IWS controller 135 is aware of the communications link between wireless terminal 105 and base station 123-m of packet-data network 101.

IWS controller 135 may thus generate a Generic Circuit Services Notification Application (GCSNA) message including a page message, and the GCSNA message (including the page message) may then be tunneled from IWS controller 135 through mobility controller 121 and base station 123-m of packet-data network 101 to wireless terminal 105 to notify wireless terminal 105 of the incoming call request.

If the GCSNA message that is tunneled through the packet-data network 101 to wireless terminal 105 includes only a page message (without providing a calling party number), however, wireless terminal 105 may only receive the calling party number (for caller ID purposes) after wireless terminal 105 is established on a traffic channel with circuit-switched network 103, and thus, after communications with packet-data network 101 have been interrupted/terminated. Once wireless terminal 105 is established on a traffic channel with circuit-switched network 103, the calling party number may be forwarded to wireless terminal 105 (for caller identification purposes), wireless terminal 105 may provide an alert (e.g., ringtone), wireless terminal 105 may provide the calling party number on a display of user interface 147, and a user (e.g., subscriber) of wireless terminal 105 may decide to either accept or reject the voice call request. By automatically interrupting communications between wireless terminal 105 and packet-data network 101 responsive to the GCSNA message including the page message (before providing the calling party number to the user), service provided by packet-data network 101 may be interrupted/terminated even if the user ultimately decides to not accept the incoming call request.

Wireless terminal 105, for example, may be engaged with packet-data network 101 in a time sensitive packet-data service, and the time sensitive packet-data service may be terminated responsive to the GCSNA message (including the page message) whether the user wants to accept the call request or not. Accordingly, the packet-data network service may be terminated due to a time-out condition because wireless terminal 105 is not communicating with packet-data network 101 from the time the GCSNA message is received until the user rejects the call request and wireless terminal 105 reconnects with packet-data network 101. Automatic loss of communication with packet-data network 101 responsive to a tunneled GCSNA message (including a page message) may be an inconvenience to the user who must reestablish the packet-data service, and also a waste of traffic channel resources required to facilitate the hand-off to circuit-switched network 103 and to facilitate reestablishing the packet-data service with packet-data network 101.

According to some embodiments, IWS 135 may be configured to include both a page message and a calling party number in a GCSNA message that is tunneled through packet-data network 101 to wireless terminal 105. The GCSNA message may be received through antenna 141 and transceiver 143, and processor 145 of wireless terminal 105 and processor 145 may be configured to identify the page message included in a 1xL3 Protocol Data Unit (PDU) of the GCSNA message and the calling party number in the GCSNA message. Responsive to identifying the page message and the calling party number in the GCSNA message, processor 145 may be configured to alert the user by providing an audible alert tone or silent vibration and identify and provide the calling party number and/or other information associated with the calling party number (e.g., a name associated with the calling party number) on a display of user interface 147 for caller identification purposes. Moreover, processor 145 may be configured to delay hand-off to circuit-switched network 103 until user acceptance of the call request is received through user interface 147. Processor 145 may thus either accept hand-off to circuit-switched network 103 responsive to user acceptance of the call request, or maintain communications with packet-data network 101 responsive to user rejection of the call request. If the user is non-responsiveness to the call request, hand-off to circuit-switched network 103 or communications with packet-data network 101 is maintained based upon processor 145 configuration.

IWS controller 135 is an entity of circuit-switched network 103 that provides connectivity between circuit-switched network 103 (e.g., CDMA circuit-switched network) and wireless terminals (including wireless terminal 105) that are in communication with (also referred to as being attached) to packet-data network 101 using a tunnel that may be established when the wireless terminal first establishes communications with (or attaches to) the packet-data network 101. Communications through the tunnel (between circuit-switched network 103 and wireless terminal 105) may use GCSNA messages according to a GCSNA protocol (e.g., as defined in 3GPP2 C.S0097). Construction and decoding of GCSNA messages may be provided by IWS controller 135 and by wireless terminal 105 attached to packet-data network 101. Network elements within packet-data network 101 may have no understanding of content of these GCSNA messages because network elements of packet-data network 101 may only provide a data path for tunneled GCSNA messages.

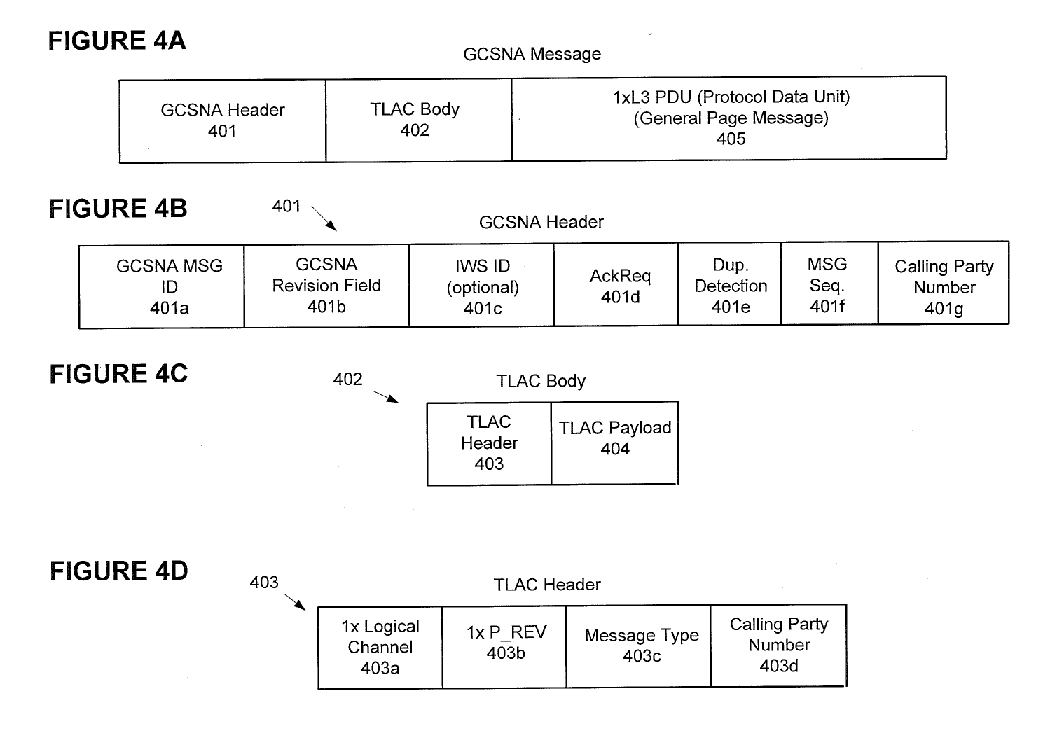

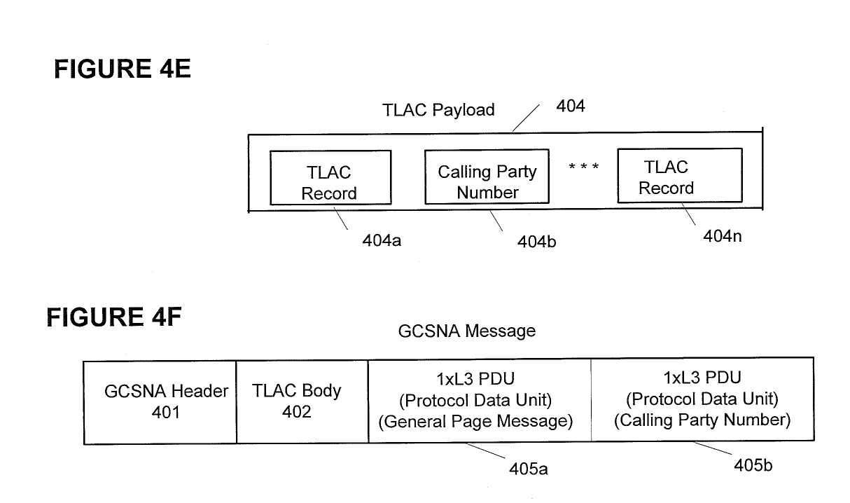

According to some embodiments shown in FIG. 4A, a GCSNA message may include three elements: GCSNA header 401, TLAC (Tunnel Link Access Control) body 402, and one or more 1x Layer 3 (1xL3) Protocol Data Units (PDUs) 405. GCSNA header 401 may include fields to ensure that wireless terminal 105 and IWS controller 135 can communicate using the GCSNA protocol (e.g., that wireless terminal 105 and IWS controller 135 are both using the same GCSNA protocol version). GCSNA header 401 may also address message duplication detection and acknowledgement. TLAC body 402 may include encapsulated CDMA circuit-switched 1x signaling message characteristics. For example, a 1x signaling message type (i.e., logical channel type), 1x P_REV info, and 1x TLAC records (e.g. addressing field records) may be included in TLAC body 402. 1xL3 PDU 405 may include an encapsulated CDMA circuit-switched 1x signaling message (as defined in 3GPP2 C.S0005), such as a 1x General Page message (also referred to as a page message).

According to some embodiments, IWS controller 135 may generate a GCSNA message (as defined in 3GPP2 C.S0097) including a 1x General Page message (as defined in 3GPP2 C.S0005) provided as a general page message in a 1xL3 PDU, and a calling party number (such as a telephone number identifying the calling device). Wireless terminal 105 may thus receive the calling party number while maintaining communication (also referred to as maintaining attachment) with packet-data network 101, and a user of wireless terminal 105 may decide whether to continue with the packet-data service by rejecting the call request or to accept the call request after having seen the calling party number.

FIG. 4A is a block diagram illustrating a general format of a GCSNA message including GCSNA header 401, TLAC body 402, and one 1×L3 PDU 405 which may include a general page message. According to some embodiments, GCSNA header 401 may be modified to include the calling party number. As shown in FIG. 4B, for example, GCSNA header 401 may include calling party number field 401g in addition to GCSNA Message ID field 401a, GCSNA Revision field 401b, optional IWS ID (identification) field 401c, Acknowledgement Request field 401d, Duplicate Detection field 401e, and Message Sequence field 401f.

According to some other embodiments, TLAC (Tunnel Link Access Control) body 402 may be modified to include the calling party number. As shown in FIG. 4C, TLAC body 402 may include TLAC header 403 and TLAC payload 404, and as shown in FIG. 4D, TLAC header 403 may be modified to include calling party number field 403d in addition to 1x Logic Channel field 403a, 1xP_REF field 403b, and Message Type field 403c. In an alternative, TLAC payload 404 may be modified to include the calling party number field 404b as a TLAC Record in addition to other conventional TLAC records as shown in FIG. 4E. By including the calling party number in a field of GCSNA header 401 and/or TLAC body 402, impact to a current 1x circuit-switch state machine of wireless terminal 105 may be reduced. According to still other embodiments, a GCSNA message may be modified to include two (or more) 1xL3 PDUs 405a and 405b. For example, 1xL3 PDU 405a may include the page message, and 1xL3 PDU 4053 may include the calling party number.

Including the calling party number in the tunneled GCSNA message with the page message may be transparent to packet-data network 101. When wireless terminal 105 receives the GCSNA message, processor 145 may identify the page message in 1xL3 PDU 405 (or in 1xL3 PDU 405a of FIG. 4F). Responsive to identifying the page message, processor 145 may retrieve the calling party number from the appropriate field of the GCSNA message (e.g., from calling party number field 401g of GCSNA header 401, from calling party number field 403d of TLAC header 403, from TLAC Record 404b of TLAC payload 404, or from second 1xL3 PDU 405b), and processor 145 may provide the calling party number on a display of user interface 147. Some embodiments may thus provide the mobile with an explicit indication (e.g., the page message and/or the calling party number) that the received GCSNA message requires special handling.

Accordingly, a user of wireless terminal 105 may either accept or reject the incoming call request (corresponding to the GCSNA message) based on knowledge of the calling party number. If the user accepts the call request, processor 145 may generate a GCSNA 1x Page Response Message that is transmitted through transceiver 143 and antenna 141 to base station 123-m and tunneled through packet-data network 101 to IWS controller 135. If the user rejects the call request, processor 145 may generate a page reject message that is transmitted to IWS controller 135 (via tunneling through packet-data network 101) to instruct IWS controller 135 to reject the call request. If the user is non-responsiveness, based upon processor 145 configuration, processor 145 may generate either a GCSNA 1x Page Response Message or a page reject message that is transmitted through transceiver 143 and antenna 141 to base station 123-m and tunneled through packet-data network 101 to IWS controller 135. If a response (i.e., a GCSNA 1x Page Response Message or a page reject message) from wireless terminal 105 is not received in sufficient time, IWS controller 135 may reject the call responsive to the expiration of a timer started when IWS controller 135 sends a GCSNA message containing a page message to wireless terminal 105.

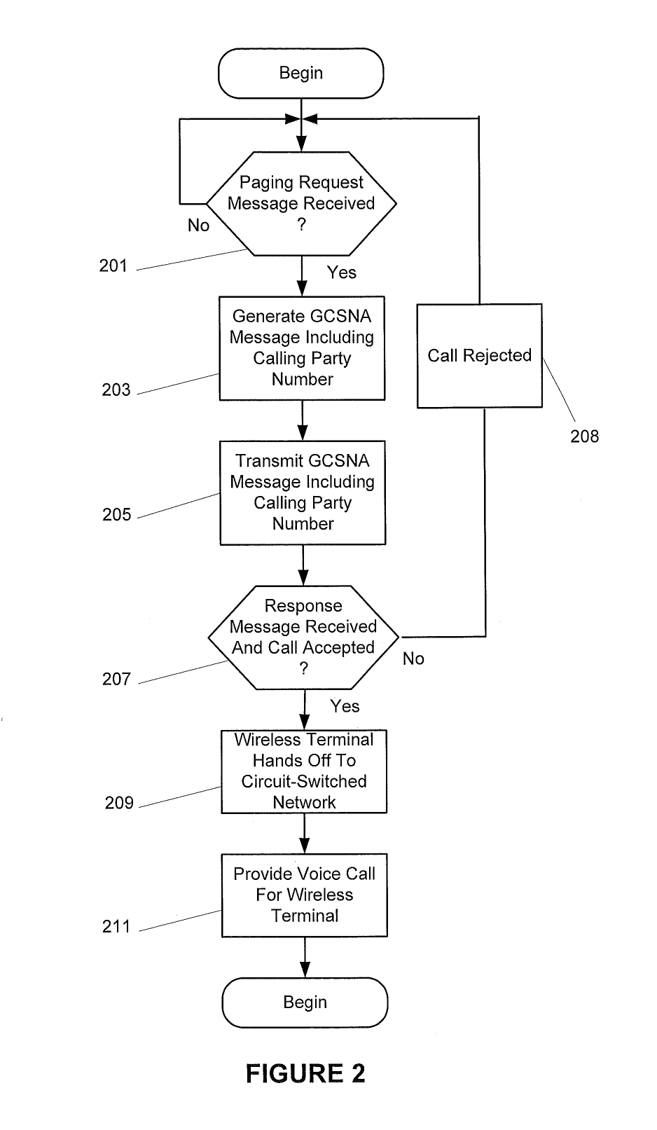

Operations of circuit-switched network 103 (e.g., a CDMA circuit-switched network) and InterWorking Solutions IWS controller 135 thereof will now be discussed with reference to the flow chart of FIG. 2. At decision block 201, IWS controller 135 may wait until a paging request message is received from mobile switching center 130. A call to wireless terminal 105 may be initiated from a remote communications device (e.g., another wireless terminal, a land-line telephone, etc.), and a call origination message (e.g., an ISDN User Part (ISUP) initial answer message) including a calling party number identifying the remote communications device making the call request may be received by MSC 130. Mobile switching center 130 may determine that wireless terminal 105 for which the call request is intended is communicating with base station 123-m of packet-data network 101.

With wireless terminal 105 communicating with base station 123-m of packet-data network 101, mobile switching center 130 may send a paging request message and/or information thereof to IWS controller 135. At block 203, IWS controller 135 may generate a GCSNA message including a page message and the calling party number identifying the remote communications device responsive to the paging request message. As discussed above, the page message may be included in a 1x L3 PDU 405/405a, and the calling party number may be included in calling party number field 401g of GCSNA header 401, in calling party number field 403d of TLAC header 403, in TLAC record 404b, and/or in second 1xL3 PDU 405b.

At block 205, IWS controller 135 may transmit the GCSNA message (including the page message and the calling party number) to the wireless terminal 105 through the packet-data network 101 (e.g., LTE packet-data network). Because the GCSNA message is transmitted through packet-data network 101 using a tunneling protocol, content of the GCSNA message may be transparent to packet-data network 101.

At block 207, IWS controller 135 may wait for receipt of a response message from wireless terminal 105. If a response message is not received from wireless terminal 105 and/or if a response message is not received from wireless terminal 105 within a specified time period (e.g., defined by the expiration of a timer started when IWS controller 135 sends a GCSNA message containing a page message to wireless terminal 105) the IWS controller 135 may reject the call at block 208.

If a response message is received from wireless terminal 105 within the specified time period at block 207 and if the response message is a GCSNA 1x Page Response Message (indicating call acceptance), IWS controller 135 may establish circuit-switched resources (e.g., a traffic channel with the circuit-switched network 103) by communicating with mobility controller 131, and at least one of base stations 133-1 to 133-n such that wireless terminal 105 can hand-off from packet-data network 101 to circuit-switched network 103 at block 209, and a voice call may be provided between wireless terminal 105 and the remote communications device through circuit-switched network 103 at block 211.

If a response message is received from wireless terminal 105 within the specified time period at block 207 and if the response message is a page reject message (indicating call rejection), IWS controller 135 may reject the call at block 208.

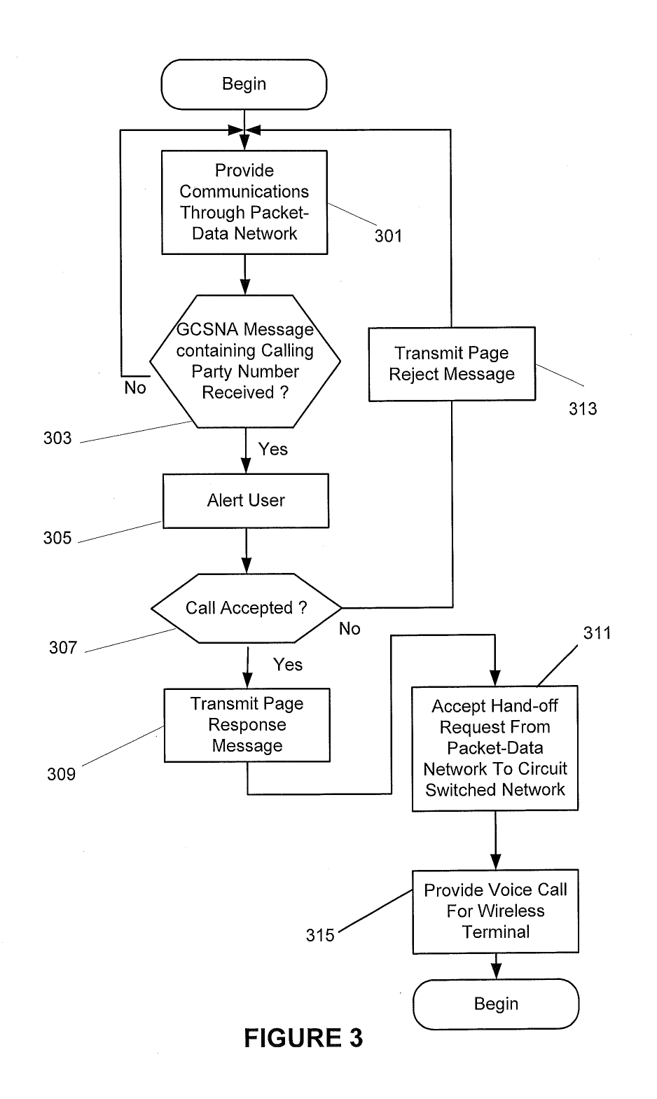

Operations of wireless terminal 105 and processor 145 thereof will now be discussed with reference to the flow chart of FIG. 3. Wireless terminal 105 may be configured to communicate with both packet-data network 101 and circuit-switched network 103, but can only communicate with one network at a time. While providing communications through packet-data network 101 at block 301, wireless terminal 105 may be unable to receive communications directly from circuit-switched network 103. Wireless terminal 105, however, may be configured to receive communications indirectly from circuit-switched network 103 using tunneled messages transmitted by IWS controller 135 through packet-data network 101.

As discussed above with respect to FIG. 2, IWS controller 135 may transmit a GCSNA message including a page message and a calling party number if a remote communications device has initiated a call (e.g., by transmitting a call origination message), and the GCSNA message may be tunneled through packet-data network 101 to wireless terminal 105. Responsive to receiving such a tunneled GCSNA message containing a calling party number at block 303, processor 145 may alert a user at block 305, for example, by providing the calling party number (from the GCSNA message) on a display of user interface 147 and by providing a audible alert tone or silent vibration.

At block 307, the call request may be accepted or rejected. If the user is non-responsive within a specified time period and processor 145 is configured to reject the call request for user non-responsiveness or if the user rejects the call request, processor 145 may generate a page reject message that is transmitted through transceiver 143 and antenna 141 at block 313 and tunneled through packet-data network 101 to IWS controller 135. Communications through packet-data network 101 are maintained. Accordingly, a user of wireless terminal 105 may elect to continue communications through packet-data network 101 (without interruption) based on knowledge of the calling party number.

If the user of wireless terminal 105 accepts the call request at block 307, processor 145 may generate a GCSNA 1x Page Response Message that is transmitted through transceiver 143 and antenna 141 at block 309 and tunneled through packet-data network 101 to IWS controller 135. At block 311, processor 145 may then accept a hand-off request from packet-data network 101 to circuit-switched network 103 responsive to the call acceptance and after transmitting the GCSNA 1x Page Response Message. Processor 145 may then provide a voice call through the transceiver 143, antenna 141, and circuit-switched network 103 after handing off to circuit-switched network 103 at block 315.

As discussed above, wireless terminal 105 may be an SRMMM wireless terminal configured to communicate with both packet-data network 101 and circuit-switched network 103 but can only communicate with cue network at a time. It will be understood that packet-data network 101 and circuit-switched network 103 may be operated by a same network operator, and that packet-data network 101 and circuit-switched network 103 may thus be considered portions of a same network. Stated in other words, an overall network may include packet-data network 101 providing communications using a packet-data radio access technology (RAT) and circuit-switched network 103 providing communications using a circuit-switched radio access technology (RAT). Moreover, components/elements of packet-data network 101 and circuit-switched network 103 may be shared.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. AU such variations and modifications are intended to be included herein within the scope of the present invention.

What is claimed is:

1. A method of providing a page from a circuit-switched network to a wireless terminal in wireless communication with a packet-data network, the method comprising:
receiving a paging request message at the circuit-switched network for the wireless terminal wherein the paging request message includes a calling party number;
responsive to receiving the paging request message at the circuit-switched network, generating a Generic Circuit Services Notification Application (GCSNA) message at the circuit-switched network including a page message and the calling party number; and
transmitting the GCSNA message including the page message and the calling party number to the wireless terminal through the packet-data network using a GCSNA tunneling protocol.

2. The method according to claim 1 wherein the page message is included in a first 1x Layer 3 Protocol Data Unit (1xL3 PDU) of the GCSNA message, and wherein the calling party number is included in a second 1x L3 PDI of the GCSNA message.

3. The method according to claim 1 wherein the Generic Circuit Services Notification Application (GCSNA) message includes a GCSNA header, and wherein the calling party number is included in a field of the GCSNA header.

4. The method according to claim 1 wherein the Generic Circuit Services Notification Application (GCSNA) message includes a Tunneled Link Access Control (TLAC) header, and wherein the calling party number is included in a field of the TLAC header.

5. The method according to claim 1 wherein the Generic Circuit Services Notification Application (GCSNA) Message includes a Tunneled Link Access Control (TLAC) payload, and wherein the calling party number is included in a field of the TLAC payload.

6. A method of operating a wireless terminal, the method comprising:
providing communications for the wireless terminal through a packet-data network; and
receiving a Generic Circuit Services Notification Application (GCSNA) message including a calling party number and a page message from a circuit-switched network wherein the GCSNA message is received from the circuit-switched network through the packet-data network using a GCSNA tunneling protocol.

7. The method according to claim 6 wherein the page message is included in a first 1x Layer 3 Protocol Data Unit (1xL3 PDU) of the GCSNA message, and wherein the calling party number is included in a second 1xL3 PDU of the GCSNA message.

8. The method according to claim 6 wherein the Generic Circuit Services Notification Application (GCSNA) message includes a GCSNA header, and wherein the calling party number is included in a field of the GCSNA header.

9. The method according to claim 6 wherein the Generic Circuit Services Notification Application (GCSNA) message includes a Tunneled Link Access Control (TLAC) header, and wherein the calling party number is included in a field of the TLAC header.

10. The method according to claim 6 wherein the Generic Circuit Services Notification Application (GCSNA) message includes a Tunneled Link Access Control (TLAC) payload, and wherein the calling party number is included in a field of the TLAC payload.

11. A circuit-switched network comprising:
an InterWorking Solution (IWS) controller configured to,
receive a calling party number of a paging request message, and
generate a Generic Circuit Services Notification Application (GCSNA) message including a page message and the calling party number of the paging request message, and
transmit the GCSNA message including the calling party number and the page message to a wireless terminal through a packet-data network using a GCSNA tunneling protocol.

12. The circuit-switched network according to claim 11 wherein the page message is included in a first 1x Layer 3 Protocol Data Unit (1xL3 PDU) of the GCSNA message, and wherein the calling party number is included in a second 1xL3 PDU of the GCSNA message.

13. The circuit-switched network according to claim 11 wherein the Generic Circuit Services Notification Application (GCSNA) message includes a Tunneled Link Access Control (TLAC) header, and wherein the calling party number is included in a field of the TLAC header.

14. The circuit-switched network according to claim 11 wherein the Generic Circuit Services Notification Application (GCSNA) message includes a Tunneled Link Access Control (TLAC) payload, and wherein the calling party number is included in a field of the TLAC payload.

15. The circuit-switched network according to claim 11 wherein the Generic Circuit Services Notification Application (GCSNA) message includes a GCSNA header, and wherein the calling party number is included in a field of the GCSNA header.

16. A wireless terminal comprising:
a transceiver configured to provide radio communications with a packet-data network and with a circuit-switched network; and
a processor coupled to the transceiver, wherein the processor is configured to provide communications through the transceiver with the packet-data network, and to receive a Generic Circuit Services Notification Application (GCSNA) message including a calling party number and a page message from the circuit-switched network while providing communications with the packet-data network, wherein the GCSNA message is received from the circuit-switched network through the packet-data network and the transceiver using a GCSNA tunneling protocol.

17. The wireless terminal according to claim 16 wherein the page message is included in a first 1x Layer 3 Protocol Data Unit (1xL3 PDU) of the GCSNA message, and wherein the calling party number is included in a second 1xL3 PDU of the GCSNA message.

18. The wireless terminal according to claim 16 wherein the Generic Circuit Services Notification Application (GCSNA) message includes a Tunneled Link Access Control (TLAC) header, and wherein the calling party number is included in a field of the TLAC header.

19. The wireless terminal according to claim 16 wherein the Generic Circuit Services Notification Application (GCSNA) message includes a Tunneled Link Access Control (TLAC) payload, and wherein the calling party number is included in a field of the TLAC payload.

20. The wireless terminal according to claim 16 wherein the Generic Circuit Services Notification Application (GCSNA) message includes a GCSNA header, and wherein the calling party number is included in a field of the GCSNA header.
